(19) United States
(12) Patent Application Publication
(10) Pub. No.: US 2003/0078969 A1
(43) Pub. Date: Apr. 24, 2003

(54) Synchronous control of media in a peer-to-peer network

(75) Inventors: Michael Sprague, New York, NY (US); Eric Beckman, New York, NY (US)

Correspondence Address: BOURQUE & ASSOCIATES, P.A., Suite 303, 835 Hanover Street, Manchester, NH, 03104, US

(73) Assignee: Wavexpress, Inc.

(21) Appl. No.: 10/012,904

(22) Filed: Oct. 19, 2001

(51) Int. Cl. G06F 15/16

(52) U.S. Cl. 709/204

(57) ABSTRACT

In a peer-to-peer multi-media communication network, a system for controlling a broadcast viewing experience of one user (second user) by a first user. Each user has access to a user workstation including at least an input device and a display device. The second user's workstation includes a storage device for storing at least user input for controlling a display on a display device coupled to the second user workstation. The first user workstation includes a dynamic display controller, responsive to an input device on the first user workstation, for receiving input from the first user workstation and for transmitting the user input to at least the second user workstation. The user input received by the second user workstation controls the display on the second user workstation display device.

### FIELD OF THE INVENTION

The present invention relates generally to a system and method of creating and sharing enhancements to and in connection with a broadcast program to enhance the viewing experience of a number of viewers of the broadcast program. More particularly, the present invention concerns a method of synchronously controlling another party's media (computer, television, etc.) in a peer-to-peer network configuration.

### BACKGROUND OF THE INVENTION

Prior art systems are known which integrate television broadcasts with other video or audio content such as a stream of data broadcast over the internet. Additionally, instant messaging and/or chat room interfacing over the internet, World-Wide-Web or other network is also known. Such prior art, however, does not allow one party to synchronously and dynamically control another party's media in a peer-to-peer network to create a truly interactive display for a user.

### BRIEF DESCRIPTION OF THE DRAWINGS

The present invention will be better understood by reading the following detailed description, taken together with the drawings wherein:

FIG. 1 is a schematic diagram of one exemplary system embodying the principles of the present invention, wherein multiple users view a broadcast program and simultaneously share information over a wide area network;

FIG. 2 is a more detailed schematic diagram of each viewer display and manipulation system according to the present invention;

FIG. 3 is a more detailed schematic diagram illustrating the inputs to a dynamic display controller of the present invention and an exemplary dynamically changed output;

FIG. 4 is diagram showing the multiple layers that are displayed on a viewer display device;

FIG. 5 shows a converged display including the multiple layers of FIG. 4, including a background layer for displaying a broadcast program and a user-prepared enhancement overlay layer;

FIG. 6 is a schematic diagram of another exemplary system embodying the principles of the present invention, wherein multiple system users enhance a broadcast program via a set of multi-media tools provided by a Web server over the Internet;

FIG. 7 is another diagram showing the multiple layers that are displayed on a viewer display in the embodiment of FIG. 6;

FIG. 8 shows a converged display including the multiple layers of FIG. 7, including a broadcast program (background) layer, a user-prepared enhancement overlay layer and a multi-media tool overlay layer; and

FIG. 9 is a flow chart of one exemplary method of generating, providing and displaying user-prepared enhancements to a plurality of viewers of a broadcast program.

### DETAILED DESCRIPTION OF THE PREFERRED EMBODIMENT

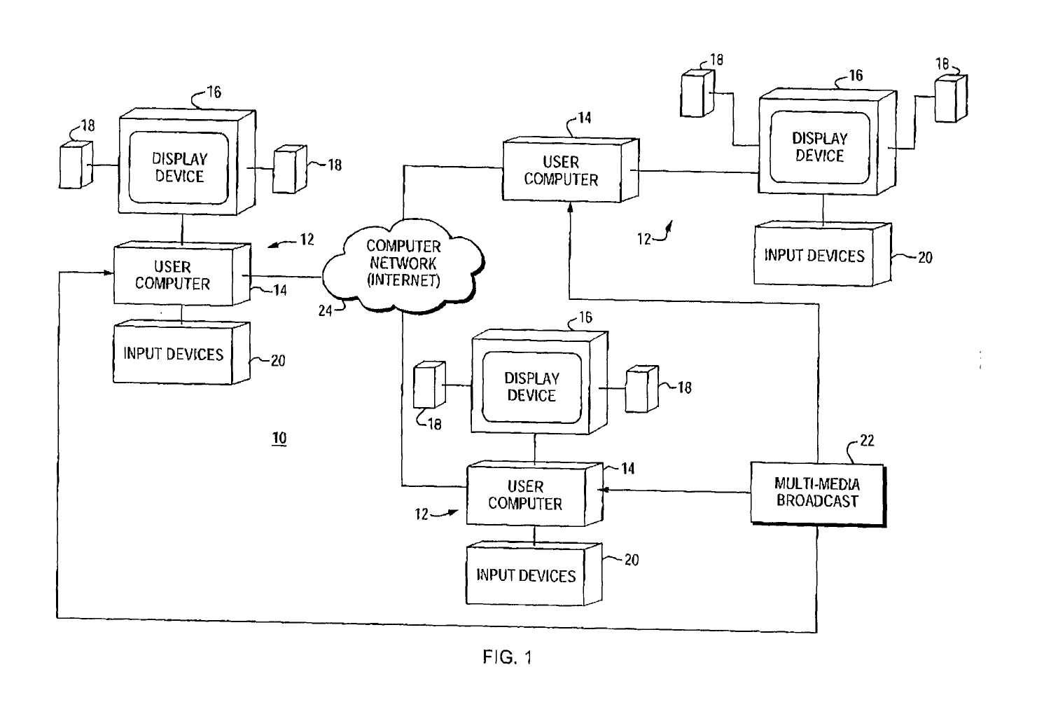

A system 10, FIG. 1, on which the present invention can be utilized and which embodies the present invention, includes a plurality of multi-media presentation systems (workstations) 12 maintained by a plurality of system users or viewers, typically at least two. (The term user and viewer will be used interchangeably in the remainder of this description and should be construed to mean a person who perceives a broadcast program using his or her senses, including but not limited to sight and hearing.) The term multi-media presentation system is used herein to indicate a system capable or presenting audio and video information to a user. However, the presentation of more than one media should not be construed as a limitation of the present invention. Examples of such multi-media presentation systems 12 include personal computer (PC) systems, PC televisions (PCTVs) and the like.

Each multi-media presentation system 12 typically includes a viewer computer 14, at least one display device 16, such as a monitor or television set, and at least one audio output 18, such as one or more speaker that may be an internal component of a television set display device or provided as a separate speaker or multiple speakers. Each user multi-media presentation system 12 also includes at least one input device 20, such as a keyboard, mouse, digitizer pad, writing pad, microphone, camera or other pointing or input generating device which allows the user to provide user input the workstations 12.

As will be described more fully below, each multi-media presentation system 12 is typically adapted to receive at least one broadcast program signal 22, which may be provided in the form of broadcast television programming (including cable and satellite television), closed circuit television, Internet web-TV or the like, received by means of a standard television broadcast signal over the air waves, cable television or satellite television, utilizing a tuner in each user computer 14. In addition, each multi-media presentation system interfaces with a computer network 24, which may be provided in the form of a local area network (LAN), a wide area network (WAN), telephone network or a global computer network, such as the Internet (World-Wide-Web).

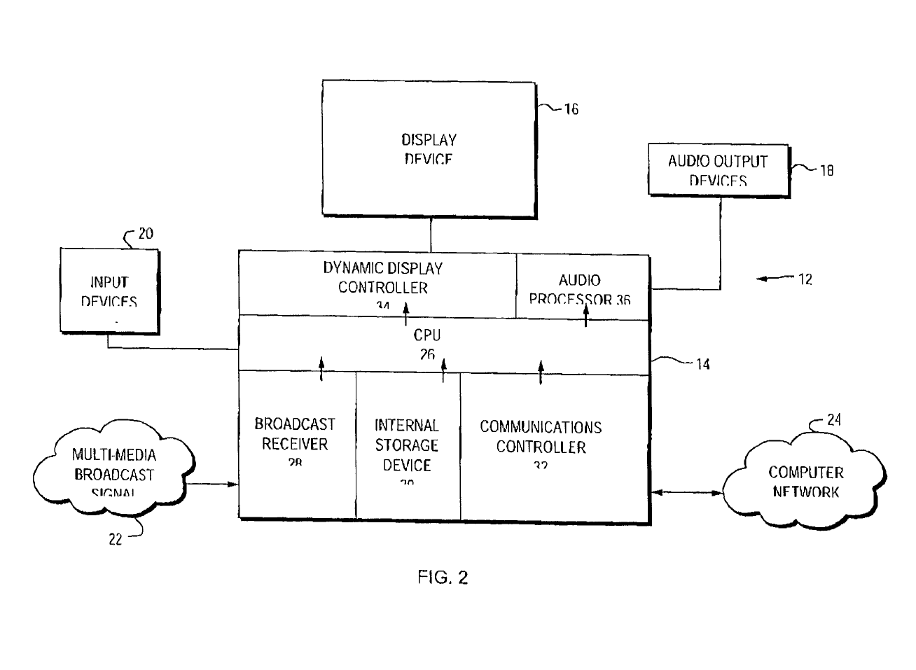

The components of one example of a multi-media presentation system/workstation 12 are shown in FIG. 2. The heart of each such system is the user computer 14. Each user computer includes a central processing unit (CPU) 26, which controls the functions of the presentation system. The CPU interfaces a broadcast receiver 28, which itself receives, as its input, the broadcast program signal 22. In one embodiment, the broadcast receiver 28 is a broadcast channel tuner that receives broadcast signals from a source such as a television broadcasting station or other programming provider or source.

Each user computer 14 also includes one or more internal storage devices 30, such as a disk drive, memory or CD ROM where data, including user input from other users or from within the same workstation, overlays, or other data related to the display on the user workstation may be stored. A communications controller 32 is also provided in each user computer 14, to control inputs received from and outputs transmitted to the other viewers via computer network 24. The communications controller 32 may act as a second receiver for receiving a second data stream provided to the user computer over the computer network. In the preferred embodiment, the communications controller 32 may include a device such as a modem (for example, a telephone, RF, wireless or cable modem) and/or a network interface card that receives information from a local or wide area network.

A dynamic display controller 34 (also referred to herein as a broadcast browser) is also provided with each user computer 14. The dynamic display controller interfaces the CPU 26, broadcast receiver 28 and communications controller 32 and receives, as input, the multiple data streams provided to the user computer by one or more of the broadcast program signal 22, the computer network 22 (via the communications controller 32) and the internal storage device 30. The dynamic display controller 34 merges the multiple input signals and outputs a merged data signal to the display device 16. An audio processor 36 may also be provided, as necessary, to receive audio data from the multiple data sources and to provide the same to the audio output device(s) 18.

In the preferred embodiment of the present invention, which is disclosed for illustrative purposes only and not considered a limitation of the present invention, the dynamic display controller 34 is implemented as computer software in the form of a browser user interface operating on the user computer 14, which is typically a personal computer or other similar individual computer workstation. Other embodiments contemplated include a client server configuration whereby a user computer 14 is connected to a server (not shown) that contains all or at least part of such computer software forming the dynamic display controller 34.

Each multi-media presentation system 12 also includes at least one input device 20, which allows a first user to direct input to the dynamic display controller 34 to control what is displayed on the display device 16, thereby allowing the user to control (i.e. generate) their viewing experience and in addition, to control the saving and/or displaying of the experience to the remaining users of the system 10, as will be explained in greater detail below.

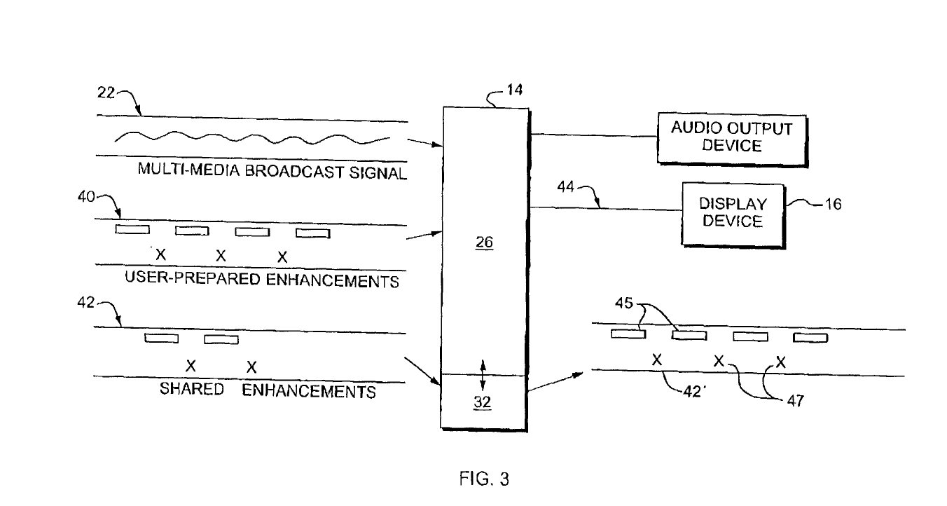

As can be seen more clearly from FIG. 3, each user computer CPU 26 receives, as a first input, a first data stream, such as a multi-media broadcast program signal 22 via broadcast receiver 28. It may also receive, as a second input, a data stream 40 including one or more third party, user-prepared, enhancements or additions to the broadcast signal input by a system user using one or more input device 20. Typically the user would interject images (video, hand drawn images, pictures, clip art, or the like), objects, audio (voice or other sound(s)) and/or text (instant message (IM) or chat, which will be displayed on his or her display device 16. In this manner, a user can dynamically create a user experience in accordance with his or her personal preferences. As will become more fully apparent below, this user can also share his or her dynamically created user-prepared enhancements with other system users, to enhance their viewing experience or allow others to further modify and share their experience as well. The user an also create a data stream which can control another user's viewing experience such as by controlling the broadcast station that another user's display device is tuned to, or store data to another user's storage device for later recall and displaying.

As a third optional input, each user computer CPU may receive, via communications controller 32, a third data stream 42, which is made up of shared enhancements to the broadcast program signal which were created by other user(s) of the system and transmitted to the user's computer over the computer network 24.

The user computer CPU 26 merges the two or more data streams and provides a merged signal 44 to the display device 16. The CPU also provides, to communications controller 32 and under control of the dynamic display controller, a data stream made up of the user-prepared enhancements, which the communications controller 32, in turn, transmits as a shared enhancement data stream 42′ to the other users of the system. The user enhanced data stream 42′ can include information to be displayed on a display as well as trigger or alignment indications 47 which can be used to synchronize the user enhanced data stream 42′ with a broadcast presentation on another user's display device. In this embodiment, the system may include, on one or more user workstations 12 pattern recognition software or other means to align the user enhanced data stream 42′ with an image pattern on a broadcast signal using one or more well known pattern recognition or “signature” type algorithms. The enhanced data stream 42′ may also be stored on the creating user's or receiving user's internal storage device 30 for later replay or later transmission to others.

As can be appreciated, using such a system, a user can enhance not only his or her viewing experience by preparing user-prepared enhancements, but he or she can also enhance the viewing experience of any or all users of the system by sharing his or her user-prepared enhancements to the other users of the system or by forcing the display device of another user to be switched to another display (i.e. television channel) with or without enhancement, thereby creating a “community” viewing experience for any or all connected/subscribed users.

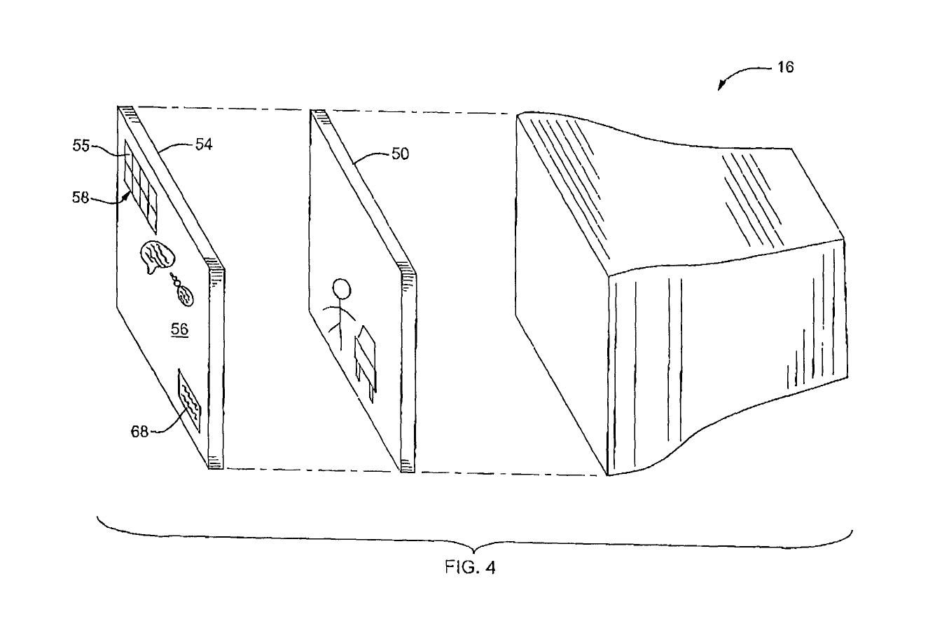

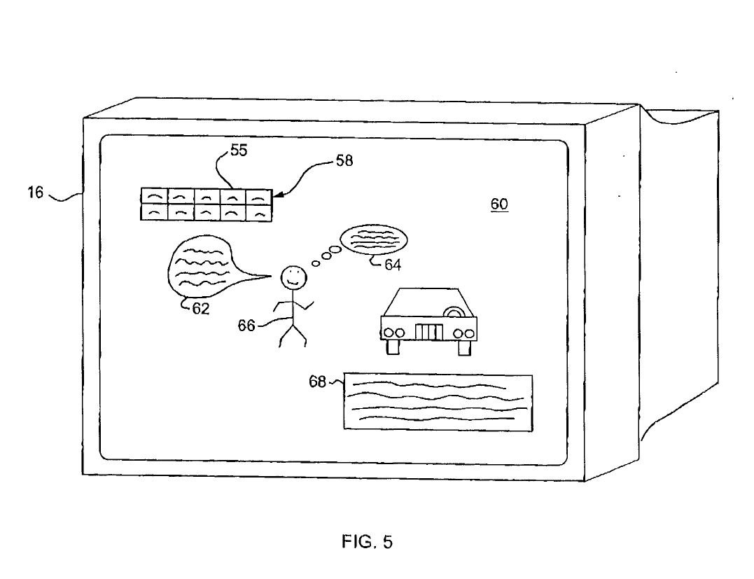

FIGS. 4 and 5 show how a layering or “overlay” strategy is utilized by the dynamic display controller 34 to control the display of the data provided by a broadcast signal and data representing user-prepared enhancements so that all of the data may be displayed in a single window or screen on each display device 16. The dynamic display controller displays, in a “background” layer 50, the broadcast signal. Then, an overlay is displayed in the same window in at least one additional layer 54 on top of the background layer 50. (It is understood that the order or layers can be reversed, if desired.) In order to allow the broadcast signal in the background layer 50 to be visible through the second or overlay layer 54, the second layer utilizes a substantially transparent background 56 or, as is disclosed herein, a background from a tool set called or named “broadcast” to signify the source of the background information.

The system also provided a plurality of user-selectable multi-media tools 56, which are provided in the form of a toolbar 58, typically although not necessarily displayed on the overlay layer 54. The toolbar 58 may be positioned to any portion of the screen as the user desires as is well known in the art. The user-selectable tools 56 allow a user to manipulate the overlay to modify the layers displayed on his or her display device.

Examples of user-selectable tools include drawing tools that allow a user to reference or comment on one or more objects appearing in the underlying broadcast signal on the background layer of the display. Such drawing tools may include lines, arrows, and text boxes, thought bubbles, speech bubbles and the like. The user-selectable tools may also include one or more graphic insertion tools, which are responsive to a user input, to insert a graphic (image, picture, drawing, video clip, etc.) obtained from a graphic library into the overlay being displayed in the additional layer 54. Such graphics libraries may be stored in internal storage 30 provided by the user computer or may be stored in remote databases, which are accessible via the computer network.

The user-selectable multi-media tools may also include an audio device to receive, store, edit and/or otherwise provide user-prepared auditory enhancements to the broadcast program. Of course, like the video signals transmitted to the other users, user-prepared auditory enhancements can also be transmitted to the additional system users over the computer network where they would be output on audio output devices included at each user's multi-media presentation system.

In addition to the text, graphic and audio tools, the toolbar may also include a user-selectable delivery icon, which can be used by the user to trigger the delivery of any user-prepared enhancements to those of the plurality of additional system users who are included on a delivery list maintained by the user of the system that has created the user-prepared enhancements. Of course, only those additional system users that are logged onto their system and viewing the same underlying broadcast program as the user creating the enhancements will be able to display or otherwise output the shared enhancements on their display or audio output devices however, the user created enhanced broadcast may be stored on a storage device of another a user for viewing at la later time by the user.

When the multiple data streams are merged, the resulting display appearing on the display device will appear in a single window 60, where the user-prepared enhancements will directly coincide with the portions of the underlying broadcast data stream to which they are directed if the user creating the enhancement creates and sends/stores them as they coincide with the broadcast signal the.

For example, speech bubbles 62 or thought bubbles 64 can be positioned adjacent a character 66 to which the speech or thought is to be attributed, text or speech inserted, and then transmitted (such as by hitting the return key or clicking the “mouse” button) or stored such that the respective alignment of the enhancements with the broadcast signal is maintained. Text boxes 68 may be positioned where they will minimize interference with important objects appearing in the underlying broadcast. Text boxes 68 may include an “instant message” or a chat window, both of which can also be used to change or affect the display of another user.

An additional tool may also include a tool to change the display of another user to a channel of the first user's choice either immediately or later.

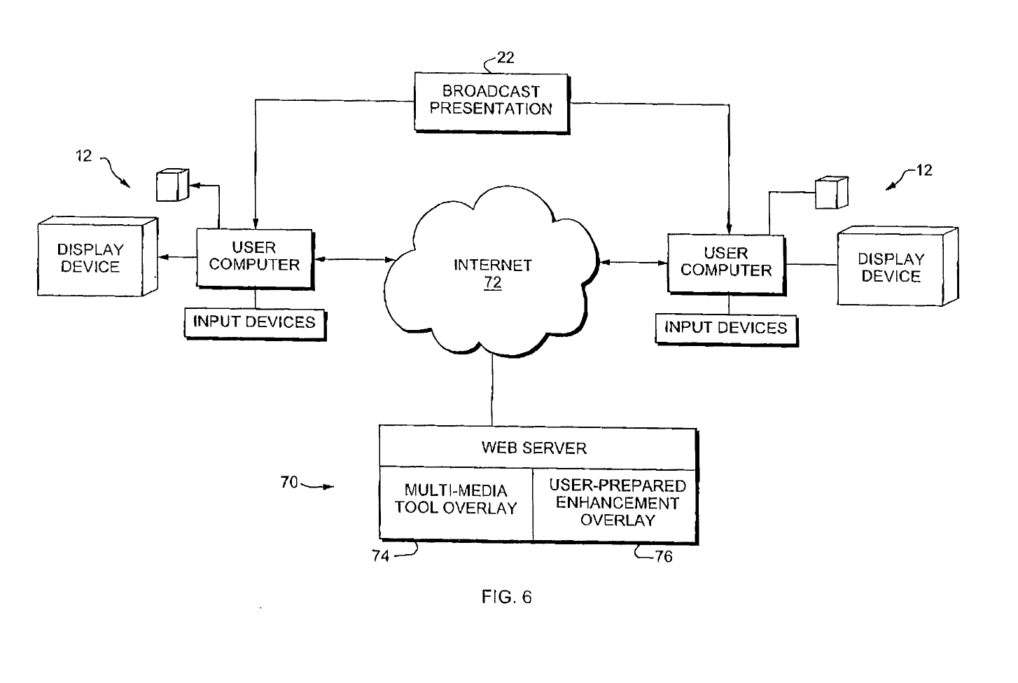

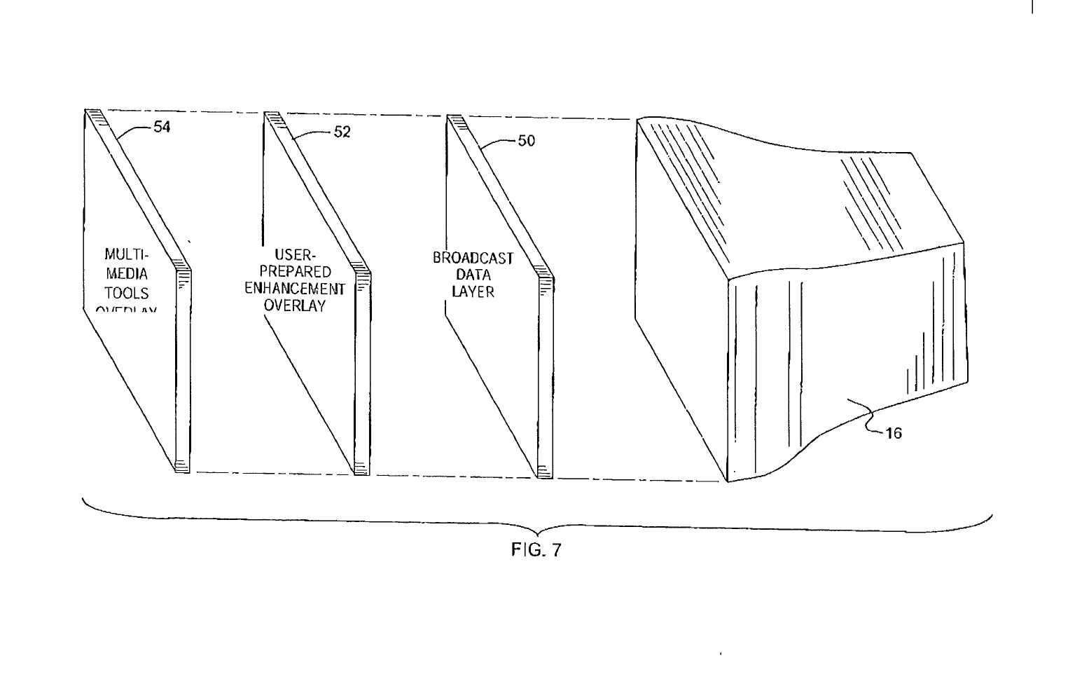

FIGS. 6-8 show an alternative embodiment of a system 10 for communicating between a plurality of multi-media presentation participants. In this embodiment, each user multi-media presentation system 12 interfaces with a Web server 70 via the Internet 72. The Web server 70 provides a multi-media tool overlay 74 as well as a user-prepared enhancement overlay 76.

Each user multi-media presentation system 12 is similar to those described above with respect to the embodiment of FIGS. 1 and 2. However, instead of storing a multi-media tool overlay in local system memory and having the dynamic display controller retrieve the overlay from the system memory, in this embodiment, each user computer accesses the web server 70, where the overlay information is maintained. Nonetheless, each user computer would still include a dynamic display controller 34 for merging the overlay information accessed and manipulated via the web server with the broadcast presentation 22 received directly by each user system.

In this embodiment, since multiple users will access a common multi-media tool overlay 74, a display strategy utilizing three or more layers may be utilized. In this manner, each system user can access the same tool overlay and use the tool overlay to create and store user-prepared enhancements to the broadcast signal that are stored on a third display layer 52. Each user will have a unique third display layer 52, which may also be referred to as a user-prepared enhancement overlay. While there will be a common multi-media tools overlay, each user will create his or her own user-prepared enhancement overlay.

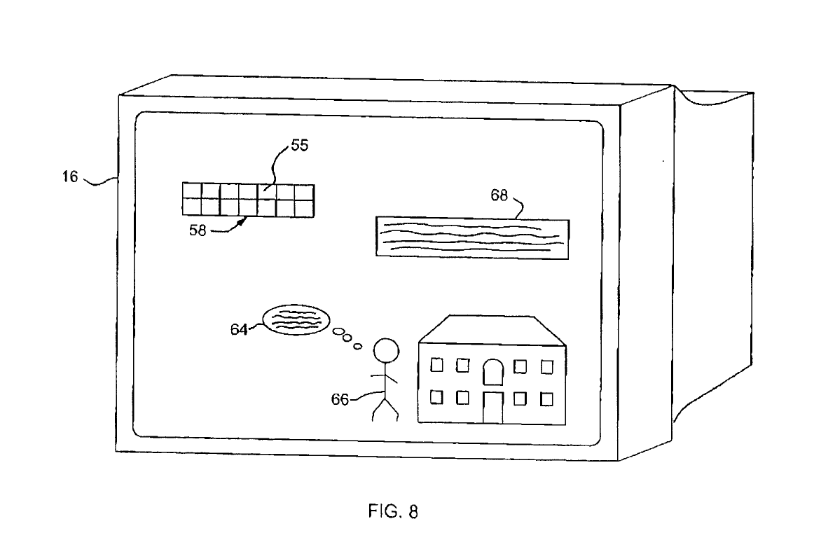

The user-prepared enhancement overlay will then be transmitted to the other users of the system in a manner similar to that described above with respect to the self-contained, peer-to-peer system of FIGS. 1 and 2. Once the layers are merged by the dynamic display controller, the use of transparent backgrounds on the each overlay layer will allow the display to appear as if the user-prepared enhancements were simply inserted into the underlying broadcast as is shown in FIG. 8.

In order to emphasize user-prepared enhancements, a special tool may be provided with the plurality of multi-media tools. This tool will be referred to as a “broadcast mute” tool. The purpose of the broadcast mute “tool” is to dampen or otherwise minimize the interference of the underlying broadcast signal so that the user-prepared enhancement overlay appear more prominently in the merged display. One means by which the broadcast mute feature may emphasize the user-prepared enhancement overlay is to provide a video mute feature. The video mute feature may be implemented as a control for the brightness and/or contrast signal of the underlying broadcast signal sent to the display device. By lowering either or both of the brightness or contrast signal to the display device, the appearance of the broadcast data in the merged display will be dampened so that the user-prepared enhancements will be more prominent. Since the purpose of the broadcast mute tool is to provide emphasis to the user-prepared enhancements, when such enhancements are provided to the remainder of the users as shared enhancements, selection of the broadcast mute tool will affect the underlying broadcast signal of all users to whom the enhancement is shared.

In a similar manner as the broadcast mute tool, the tool set 58 may also include an audio mute tool. The audio mute tool will operate generally in a similar manner to the video mute tool. However, instead of affecting the underlying broadcast's video signal, it would allow audio enhancements to be highlighted by reducing the volume of the underlying broadcast signal. Of course both the video mute and audio mute features could be used together.

A method of generating and providing user-prepared enhancements to a plurality of viewers of a broadcast program 100 is shown in FIG. 9. To utilize the method, a plurality of viewers of the broadcast program will utilize a display device for viewing the broadcast program. Each viewer will also have a computer for controlling the display device and for interfacing each user to the other viewers over a computer network.

The method 100 begins by displaying a broadcast program in a background layer on at least one viewer display device, act 110. Next, at least one overlay layer is provided on each viewer display device, act 120. Each overlay layer includes a transparent background to allow the broadcast program being displayed on the background layer to “bleed through”. At least one of the overlay layers includes a plurality of user selectable multi-media tools, which are responsive to user input, for manipulating at least one overlay layer by including user-prepared enhancements thereupon.

Then, user interaction with the provided multi-media tools is monitored and any user-prepared enhancements input by a viewer using the tools is stored, act 130. The user-prepared enhancements are then transmitted to any additional users of the system who are viewing the underlying broadcast presentation, act 140. Preferably, the user-prepared enhancements are transmitted in response to a user selectable delivery icon so that the user can complete the user-prepared enhancement and then deliver the enhancement when he or she so desires and to whom he or she desires.

In act 150, the user-prepared enhancement that has been transmitted to the additional system users is either displayed on at least one overlay layer on top of the broadcast layer being displayed on a display device at a receiving user's system or stored on a storage device which is part of the receiving user's system. Next, the user prepared enhancement that has been received can be used to control the display of the receiving user including changing a broadcast channel of the user either immediately of at a predetermined time or date in the future.

Accordingly, the system and method described above, which embody the present invention, allows viewers of a broadcast presentation to enhance their own viewing experience and enhance the viewing experience of others by dynamically and synchronously preparing, changing and sharing multi-media enhancements to the underlying broadcast presentation.

Modifications and substitutions by one of ordinary skill in the art are considered to be within the scope of the present invention that is not to be limited except by the claims which follow.

What is claimed is:

1. In a peer-to-peer multi-media communication network, a system for controlling a broadcast viewing experience of one user by another user, the system comprising:
a first user workstation including at least an input device and a display device;
a second user workstation, coupled to said first user workstation, and including a storage device for storing at least user input for controlling a display on a display device coupled to said second user workstation; and
said first user workstation further including a dynamic display controller, responsive to said first user workstation input device, for receiving input from said first user workstation and for transmitting said user input to at least said second user workstation, said user input for controlling said display on said second user workstation display device.

2. The system of claim 1 wherein said display includes a broadcast presentation.

3. The system of claim 2 wherein said broadcast presentation includes a television broadcast presentation.

4. The system of claim 1 wherein said system synchronously and dynamically controls said broadcast viewing experience of one user by another user.

5. The system of claim 1 wherein said communication network is selected from the group consisting of a computer network, telephone network, a wide area network, a local area network, and the World-Wide-Web.

6. The system of claim 1 wherein said user input from said first user workstation is stored on said storage device of said second user workstation for later display on said second user workstation.

7. The system of claim 6 wherein said user input controls when said display will occur on said second user workstation.

8. The system of claim 6 wherein said stored user input controls what will be displayed on said second user workstation.

9. The system of claim 1 wherein each of said first and second user workstations include a multi-media display device displaying a broadcast presentation including a single window layered display and a computer controlling said multi-media display device and interfacing each of said first and second workstations over a computer network, said single-window layered display including:
a broadcast layer, for displaying said broadcast presentation in a background layer of said layered display; and
at least one overlay displayed in at least a second layer of said layered display on top of said broadcast layer on said single-window, layered display, said at least one overlay having a substantially transparent background and allowing said broadcast presentation in said broadcast layer to be viewed through said at least one overlay.

10. The system of claim 9 wherein said at least one user workstation includes a plurality of user-selectable multi-media tools, for allowing a user at said first user workstation to manipulate said at least one overlay to add user-prepared enhancements to said broadcast presentation, and wherein said dynamic display controller transmits said user-prepared enhancements to at least said second user workstation.

11. The system of claim 9 wherein said user input includes an instant message to be displayed on said at least one overlay.

12. The system of claim 9 wherein said user input includes a chat message to be displayed on said second user workstation.
